(19) United States
(12) Patent Application Publication
(10) Pub. No.: US 2026/0357696 A1
(43) Pub. Date: Nov. 12, 2026

(54) TRACER PARTICLES WITH A LAYER-BY-LAYER STRUCTURE FOR SUBTERRANEAN APPLICATIONS

(71) Applicant: Core Laboratories LP, Houston, TX (US)

(72) Inventors: Khanh B. Vu, Houston, TX (US); Swathika Jayakumar, Houston, TX (US); Ofelia Dolores Rojas Reyes, Houston, TX (US)

(21) Appl. No.: 19/673,494

(22) Filed: May 11, 2026

Related U.S. Application Data
(60) Provisional application No. 63/804,160, filed on May 12, 2025.

(51) Int. Cl. E21B 47/11; C09K 8/035; G01F 1/704

(52) U.S. Cl. CPC E21B 47/11; C09K 8/035; G01F 1/704

(57) ABSTRACT

A tracer particle with a layer-by-layer structure is provided. The tracer particle includes a core, a chemically bonded amine layer, one or more oligonucleotide layers, one or more physically bonded amine polymer layers, a shell, and a stabilization-assisted layer. The tracer particle further includes one or more physically bonded short amine molecules, one or more metallic cation layers. The method includes adding a plurality of tracer particles into a fluid and introducing the fluid into subterranean formation and detecting a presence of the plurality of tracer particles.

### CROSS-REFERENCE TO RELATED APPLICATION

This application claims priority to and the benefit of U.S. Provisional Application No. 63/804,160, entitled “TRACER PARTICLES WITH A LAYER-BY-LAYER STRUCTURE FOR SUBTERRANEAN APPLICATIONS,” and filed May 12, 2025, which is incorporated by reference herein in its entirety for all purposes.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

The energy industry frequently engages in subsurface operations to explore and/or extract subterranean resources. Drilling is a process in which a borehole, a small diameter hole in the ground, is drilled into the Earth’s surface in order to explore and extract energy in the form of hydrocarbons and heat that lie beneath the surface. Before, during, or after the drilling process, geologists may work to determine characteristics of a subsurface formation (e.g., reservoir rock) and the surrounding area. For example, engineers and scientists may work to determine how hydrocarbons or other fluids flow within a subterranean formation. To do so, a unique marker or tracer may be introduced into the subsurface to measure and monitor reservoir characteristics. The subsurface environment within the formation can be extreme in terms of temperature, pressure, acidity, and so forth. As such, certain tracers lack the chemical and physical stability to withstand the subsurface environment. Accordingly, detectable tracers that can more readily withstand subsurface environments are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a tracer particle is produced. The tracer particle includes a layer-by-layer structure including a core, a chemically bonded amine layer, one or more oligonucleotide layers, one or more physically bonded amine polymer layers, a shell, and a stabilization-assisted layer.

In another embodiment, a method is provided. The method includes adding a plurality of tracer particles into a fluid, wherein each of the plurality of tracer particles includes a layer-by-layer structure including a core, a chemically bonded amine layer, one or more oligonucleotide layers, one or more physically bonded short amine molecules, one or more physically bonded amine polymer layers, a shell, and a stabilization-assisted layer. The method also includes introducing the fluid into subterranean formation and detecting a presence of the plurality of tracer particles.

In another embodiment, a tracer particle is produced. The tracer particle includes a core, a chemically bonded amine layer, one or more oligonucleotide layers, one or more metallic cation layers, a physically bonded amine polymer layer, a shell, and a stabilization-assisted layer.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a subterranean resource exploration and extraction system, in accordance with aspects of the present disclosure;

FIG. 2 is a diagram of an embodiment of synthesis of a tracer particle including a physically bonded amine polymer layer that may be used by the subterranean resource exploration and extraction system of FIG. 1, in accordance with aspects of the present disclosure;

FIG. 3 is a diagram of an embodiment of a process to synthesize one or more tracer particles including one or more amine molecules that may be used by the subterranean resource exploration and extraction system of FIG. 1, in accordance with aspects of the present disclosure;

FIG. 4 is a diagram of an embodiment of a process to synthesize one or more tracer particles including one or more metallic cations that may be used by the subterranean resource exploration and extraction system of FIG. 1, in accordance with aspects of the present disclosure;

FIG. 5 is a flow diagram of an embodiment of a process of detecting one or more tracer particles, in accordance with aspects of the present disclosure;

FIG. 6 is a graph of concentration of water-soluble tracers collected during different time periods from a first well, in accordance with aspects of the present disclosure;

FIG. 7 is a graph of concentration of oil soluble tracers collected during different time periods from the first well, in accordance with aspects of the present disclosure; and

FIG. 8 is a graph of concentration of oil soluble tracers collected during different time periods from a second well, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with systems-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more elements. The terms “comprising,” “including,” and “having” are intended to be inclusive and mean that there may be additional elements other than the listed elements. For purposes herein, a “polymer” has two or more of the same or different monomer (“mer”) units. For purposes herein “monolayer” is defined as a layer of one material and does not necessarily relate to an atomic layer. For purposes herein, “bilayer” is defined as a first layer of a first material and a second layer of a second material and does not necessarily relate to atomic layers. All ranges expressed herein should include both end points as two specific embodiments unless specified or indicated to the contrary. For purposes herein, “physically bonded” is defined as interactions between molecules that may be disturbed by physical changes (e.g., temperature, pressure) such as Van der Waals interactions, electrostatic interactions, intermolecular forces (e.g., hydrogen bonding). For purposes herein “chemically bonded” is defined as atomic and/or molecular interactions between components in which electrons are shared or transferred.

Tracer particles may be used in a variety of applications, such as environmental monitoring (e.g., oil and gas exploration, drilling, fracking, groundwater monitoring, soil analysis, etc.) and industrial processes (e.g., pipeline flow analysis, mixing analysis, leak detection, etc.). Tracer particles may include identifiable particles intentionally added into a system to determine flow characteristics of fluids (e.g., hydrocarbons, water, natural gas). In general, tracer particles may be used to monitor conditions (e.g., pressure, temperature, salinity, acidity, basicity, or any combination thereof) of an environment (e.g., subterranean environment, pipeline environment). For example, tracer particles may interact with the environment and may be collected and analyzed to elucidate chemical and/or environmental properties of one or more zones of the environment. As the tracer particles may be introduced to various environmental conditions (e.g., high-pressures, high-temperatures, salinity, acidity, basicity, etc.) it may be advantageous to synthesize tracer particles with improved stability and compatibility.

Accordingly, the present disclosure is generally directed to a tracer particle that may be utilized for tracking the flow of subterranean fluids (e.g., hydrocarbons and water). More specifically, the present disclosure relates to the synthesis (e.g., fabrication) and use of tracer particles for oil and gas exploration, ground water studies, and/or other subterranean flow analysis applications. One method to improve chemical compatibility, increase detection sensitivity, and/or reduce environment impact of tracer particles is to generate tracer particles using layer-by-layer (LbL) techniques (e.g., LbL synthesis or assembly) described herein. The disclosed LbL techniques may be used to form tracer particles with various layers to improve rigidity (e.g., durable, chemical stability) of the tracer particles for use in subterranean environments. Further, the disclosed LbL techniques may aid a user in incorporating multiple layers of oligonucleotides into the trace particle, while maintaining the tracer particle within a threshold diameter. It is presently recognized that adding multiple layers of oligonucleotides reduces the likelihood that the information associated with the tracer particle is lost or otherwise rendered unusable. For example, if the tracer particle includes only one oligonucleotide layer and that layer is lost, the user may be unable to determine the identity of the tracer particle. As such, it may be advantageous to include multiple layers of oligonucleotides. Further, the disclosed LbL techniques may be performed in a single reaction vessel and with reagents that each soluble in water, as opposed to using reagents that need to be washed and resuspended in different solvents or opposed to using a reverse emulsion method that includes using organic solvents as main solvents in the synthesis. In this way, the disclosed LbL techniques may be used to form particles that include layers of metals, amines, polymers, oligonucleotides, and silica that uses relatively less of certain types of materials (e.g., less organic solvents) with a reduced environmental impact as compared to other conventional techniques for preparing conventional tracer particles.

The disclosed LbL techniques may generate one or more tracer particles. The tracer particles include a functionalized core (e.g., silica nanoparticle) or other silica-containing core (e.g., materials dispersed in a silica core) including one or more layers. The one or more layers may include oligonucleotides, amines, amine polymers, metallic cations, silica, or a combination thereof. The disclosed LbL techniques may provide control of tracer particle thickness through fabrication of multi-layer particles. The layers formed on the functionalized core may be formed through chemical bonding (e.g., covalent bonding), electrostatic interactions, hydrogen bonding, van der Waals forces, metal-ligand coordination, charge transfer, hydrophobic interactions, and the like. For example, in some embodiments, the tracer particles may include a silica core, a monolayer formed by chemically bonded amines, a bilayer formed by oligonucleotides (e.g., a DNA layer, an RNA layer), one or more additional layers (e.g., physically bonded amines, metallic cations, short amine molecules, one or more repeated layers, etc.), and a silica shell. In certain embodiments, the silica shell may be formed as an outer layer of the tracer particle to enhance chemical stability and improve solubility of the tracer particles (e.g., stability of the tracer particle in suspension).

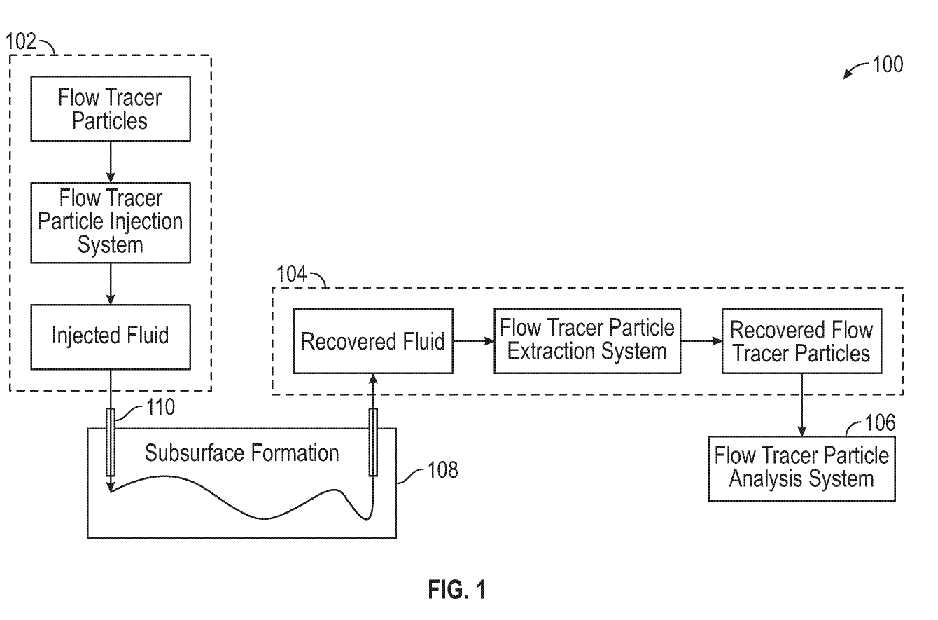

Turning to the drawings, FIG. 1 is a block diagram of a subterranean resource exploration and extraction system 100. As illustrated, the subterranean resource exploration and extraction system 100 includes a tracer particle injection system 102, a tracer particle extraction system 104, and a tracer particle analysis system 106. During an operation to explore or extract resources from a subsurface formation 108, the subterranean resource exploration and extraction system 100 injects a fluid (e.g., a working fluid, a hydraulic fracking fluid, water) into a subsurface formation 108 at a suitable inlet 110. The fluid may be either measured in situ in the subsurface formation or recovered at the surface. The subsurface formation 108 may be an underground formation that includes groundwater or hydrocarbons (e.g., oil, natural gas). As such, the tracer particle described herein may be utilized oil and gas exploration, ground water studies, geothermal energy studies, and/or other subterranean analysis applications.

As shown by the illustrated embodiment, the tracer particle injection system 102 introduces tracer particles into the fluid being injected into the subsurface formation 108. As discussed below, each of the tracer particles includes one or more layers that may be used to indicate an identity of a tracer particle (e.g., identifiable signature). The tracer particles may be dissolved or suspended in a suitable fluid (e.g., a water-based fluid, an organic-based fluid). For applications where the tracer is measuring or monitoring flow, the tracer particles are injected downhole and at least a portion of the injected tracer particles return with the recovered fluid. The tracer particle analysis system 106 and/or the tracer particle extraction system 104 may use one or more physical properties (e.g., magnetic properties, chemical properties, optical properties) of the tracer particles to detect and isolate the tracer particles from the remainder of the recovered fluid. For example, the tracer particle analysis system 106 and/or the tracer particle extraction system 104 may include centrifuges, magnets, spectroscopic excitation and detection devices (e.g., fluorescence, photoluminescence, Raman, infrared, circular dichroism, dynamic light scattering, etc.), or any other suitable devices that may be used to detect and/or isolate the tracer particles from the recovered fluid (e.g., nuclear magnetic resonance, chromatography). In some cases, the tracer particles may also be detected in-situ downhole. For example, the presence of the tracer particles may be detected downhole using magnetic sensor, spectroscopic excitation/detection devices, or other suitable techniques. Furthermore, while the tracer particle is described as being included in a fluid that is injected into the subsurface formation 108, it should be noted that the tracer particle may be included in proppant, which may also be introduced to the subsurface formation 108. For instance, the tracer particle may be included with proppant, which may be added to a fluid (e.g., fracking fluid) before the fluid is introduced into the subsurface formation 108. Accordingly, the tracer particle may be utilized as a proppant tracer.

After isolation, the recovered tracer particles may advance to the tracer particle analysis system 106. The tracer particle analysis system 106 includes suitable devices to enable the digestion of the tracer particles to release chemical fragments (e.g., amines, oligonucleotides, DNA fragments, metallic cations, etc.) from the layers of the tracer particles, as well as suitable devices to analyze the sequence of these released chemical fragments. For instance, the tracer particle analysis system 106 may include quantitative PCR (qPCR) instruments, deoxyribonucleic acid (DNA) amplifiers, or any other suitable equipment utilized to process or sequence DNA or ribonucleic acid (RNA) (e.g., sequencers, spectrometers, flow cytometers, gel electrophoresis equipment). The tracer particle analysis system 106 may also include one or more computing devices. Since the tracer particle analysis system 106 is capable of determining the sequence of oligonucleotides of tracer particles, the tracer particle analysis system 106 can determine which tracer particles were recovered when multiple tracer particles (e.g., with different DNA sequences) are injected at different points in the subsurface formation. As such, based on information related to the injection of the tracer particles (e.g., concentration, flow rate, time), and based on the identity of the recovered tracer particles determined from oligonucleotide sequencing and/or other identification methods, the subterranean resource exploration and extraction system 100 can be used to determine information regarding the flow of subsurface fluids (e.g., flow paths, flow rates, flow loss) within the subsurface formation 108.

It should be noted that the subsurface formation 108 or subsurface fluids may have certain properties or characteristics that may damage one or more layers of the tracer particles. For example, the environment of the subsurface formation 108 or the subsurface fluids may expose an oligonucleotide layer and/or amine polymers. The subsurface formation 108 may include one or more zones of high-temperature (e.g., between 40 °C and 200 °C), high-pressure, high-salinity, highly acidity, high-basicity, or a combination thereof. Each of these factors (e.g., temperature, pressure, salt, acidity, basicity), alone or in combination, may damage the layers of the tracer particles and/or the silica core. As discussed herein, the disclosed LbL techniques may be used to form one or more repeat layers to identify an extent of degradation of the tracer particles under downhole conditions (e.g., subterranean formation).

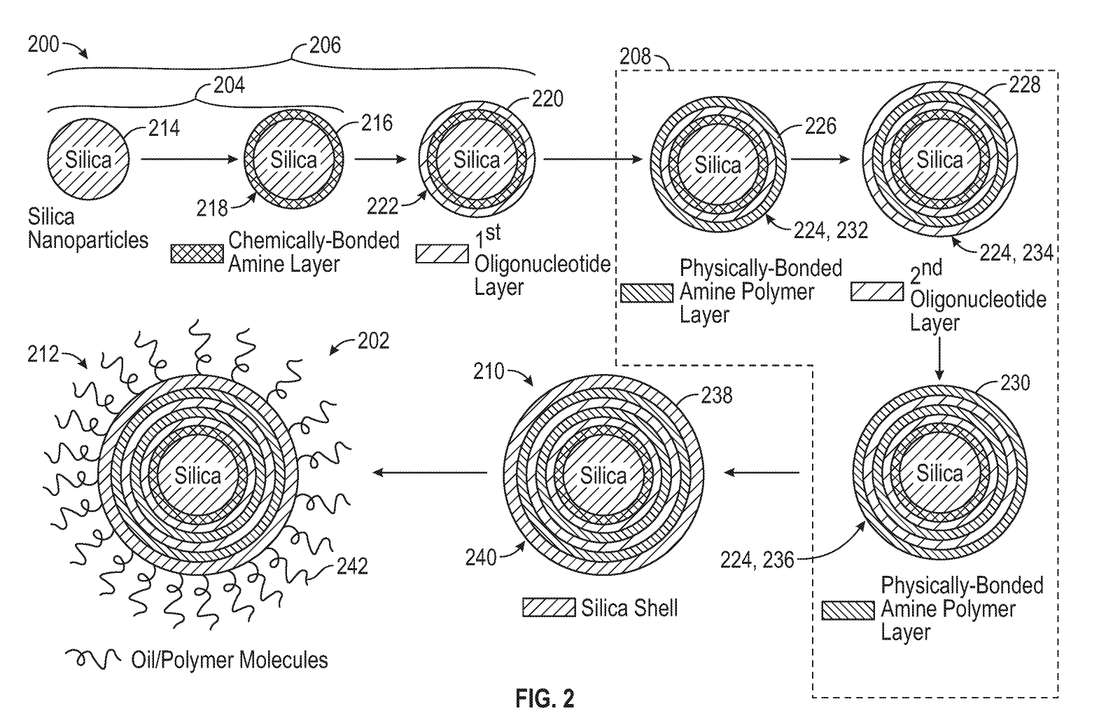

FIG. 2 is a diagram of a process 200 (e.g., an LbL assembly method) to synthesize one or more tracer particles 202 including a physically bonded amine polymer layer that may be used by the subterranean resource exploration and extraction system 100 of FIG. 1, in accordance with aspects of the present disclosure. The process 200 generally produces the tracer particles 202 through the disclosed LbL techniques, which may be used to detect downhole conditions. In some embodiments, the tracer particles 202 may be fabricated in aqueous conditions.

As shown, the process 200 may include one or more stages, such as a monolayer formation stage 204, a bilayer formation stage 206, a multilayer formation stage 208, an encapsulation stage 210, and a stabilization stage 212. The one or more stages may be used to form one or more layers including amines, oligonucleotides, or a combination thereof. It should be noted, that the illustrated stages are provided as examples and more, fewer, or different stages may be included in the process 200.

In some embodiments, the monolayer formation stage 204 includes modifying one or more silica cores 214 with a chemically bonded amine layer 216 to form a core-shell particle 218. Additionally and/or alternatively, a core of the core-shell particle 218 may be a metal oxide (e.g., metallic oxide), a polymeric polymer based core, or a combination thereof. In some embodiments, the silica core 214 may include additional materials such as metal oxide particles, polymeric particles, and the like. Surfaces of the metal oxide particles and/or the polymeric particles may be positively charged. That is, in some instances, the metal oxide particles and/or the polymeric particles may include surfaces that are intrinsically positively charged. Additionally and/or alternatively, the metal oxide particles and/or the polymeric particles may be functionalized (e.g., physical and/or chemical adsorption) with one or more positively charged functional groups. In some embodiments, the silica core 214 may be substantially-free of additional materials. As such, the silica core may include greater than 50%, 60%, 70%, 80%, 90%, or 95% of silica by volume. In some embodiments, the chemically bonded amine layer 216 may be formed on a surface of the silica core 214 via surface functionalization of the surface of the silica core 214 via silane coupling agents including amine groups. The chemically bonded amine layer 216 may include N-[3-(Trimethoxysilyl)propyl]ethylenediamine. Additionally and/or alternatively, the chemically bonded amine layer 216 may include 3-aminopropyltriethoxysilane (APTES) and/or one or more additional types of silane coupling agents. The chemically bonded amine layer 216 formed during the monolayer formation stage 204 modification may include one or more positively charged functional groups (e.g., amines) to enable bilayer formation with one or more negatively charged groups. Moreover, it is presently recognized that the chemically bonded amine layer 216 may facilitate absorption of DNA onto the tracer particle 202 by attracting the negatively charged phosphate backbone of the DNA or other oligonucleotide.

In certain embodiments, the bilayer formation stage 206 may include modifying the core-shell particle 218 with a first oligonucleotide layer 220 (e.g., a DNA layer) to form a core double-shell particle 222. In some embodiments, the first oligonucleotide layer 220 may be formed on a surface of core-shell particle 218 via electrostatic interactions between the negatively charged phosphate background of the first oligonucleotide layer 220 and the positively charged amines of the chemically bonded amine layer 216. Additionally and/or alternatively, the first oligonucleotide layer 220 may be formed on a surface of core-shell particle 218 by forming hydrogen bonds between the chemically bonded amine layer 216 and the first oligonucleotide layer 220. The first oligonucleotide layer 220 may include one or more negatively-charged oligonucleotides. The oligonucleotides may include DNA or RNA molecules of any suitable number of nucleotides. The oligonucleotides may be naturally occurring or synthetic. Furthermore, the oligonucleotides may include single-stranded oligonucleotides, double-stranded oligonucleotides, or triple-stranded oligonucleotides. In certain embodiments, the oligonucleotides may comprise one or more non-covalent physical interactions, one or more covalent chemical bonds, or combinations thereof, wherein said interactions and bonds are disposed intra-molecularly within a single oligonucleotide strand, inter-molecularly between a plurality of oligonucleotide strands, or a combination thereof. In some embodiments, the core double-shell particle 222 may include one or more negatively charged portions (e.g., negatively charged groups of the first oligonucleotide layer 220) to enable physical bonding of one or more additional layers to generate multi-layer core-shell particles.

In some embodiments, the multilayer formation stage 208 may include modifying the core double-shell particle 222 with the one or more additional layers to form one or more multilayer particles 224. As shown, the additional layers may include a first physically bonded amine polymer layer 226, a second oligonucleotide layer 228, a second physically bonded amine polymer layer 230, and the like. The multilayer particles 224 may include a first multilayer particle 232, a second multilayer particle 234, and a third multilayer particle 236. The multilayer particles 224 may be intermediate particles formed during the process 200. The multilayer formation stage 208 may generate the first multilayer particle 232 by modifying the core double-shell particle 222 with the first physically bonded amine polymer layer 226. It should be noted that the multilayer particles 224 may include more layers than shown.

The first physically bonded amine polymer layer 226 may include poly(diallyldimethylammonium chloride) (PDADMAC). PDADMAC is a water-soluble polymer that may form on the surface of the core double-shell particle 222 via electrostatic interactions between the positively charged quaternary ammonium groups and the negatively charged oligonucleotides of the first oligonucleotide layer 220. The ratio of positively-charged polymers to oligonucleotides may range from 0.5:1 to 200:1. The multilayer formation stage 208 may generate the second multilayer particle 234 by modifying the first multilayer particle 232 with the second oligonucleotide layer 228. In an embodiment, the second oligonucleotide layer 228 may be substantially similar to the first oligonucleotide layer 220. Alternatively, the second oligonucleotide layer 228 may include oligonucleotides differing from the first oligonucleotide layer 220. For example, the second oligonucleotide layer 228 may include DNA strands and/or RNA strands that may include chemical tags associated with the second oligonucleotide layer 228 enabling differentiation of the first oligonucleotide layer 220 and the second oligonucleotide layer 228 during analysis of the tracer particle 202 by the tracer particle analysis system 106 of FIG. 1. The positively charged quaternary ammonium groups of the first physically bonded amine polymer layer 226 may interact with the negatively charged oligonucleotides of the second oligonucleotide layer 228 via electrostatic interactions. As another example, in some embodiments, the charge of the oligonucleotides may be negative relative to the first physically bonded amine polymer layer 226, such as a partial negative charge that may occur for chemical species having at least one dipole moment. As yet another example, the first oligonucleotide layer 220 and the first physically bonded amine polymer layer 226 may form hydrogen bonds. For instance, in one embodiment, the first oligonucleotide layer 220 may include hydrogen bond donors, and the first physically bonded amine polymer layer 226 may be a hydrogen bond acceptor. In another embodiment, the first physically bonded amine polymer layer 226 may be a hydrogen bond donor, and the first oligonucleotide layer 220 may include hydrogen bond acceptors.

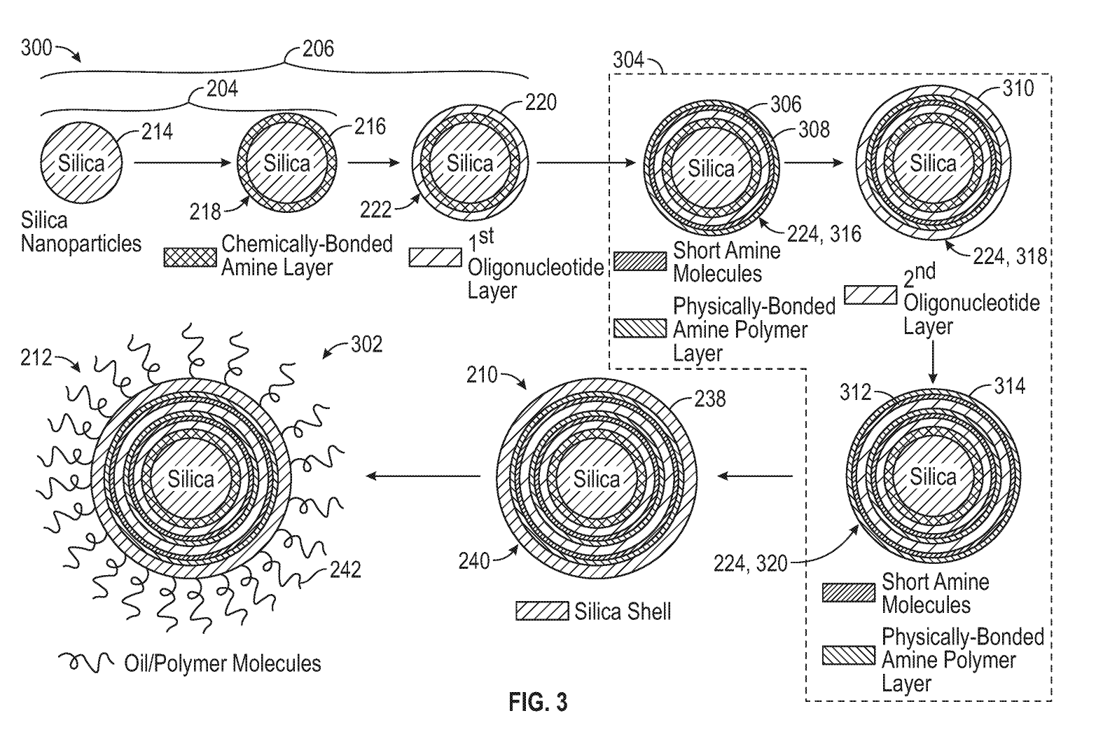

The multilayer formation stage 208 may generate the third multilayer particle 236 by modifying the second multilayer particle 234 with the second physically bonded amine polymer layer 230. In an embodiment, the second physically bonded amine polymer layer 230 may be substantially similar to the first physically bonded amine polymer layer 226. The negatively charged oligonucleotides of the second oligonucleotide layer 228 may interact with the positively charged quaternary ammonium groups of the second physically bonded amine polymer layer 230 via electrostatic interactions. It should be noted that, while the present disclosure generally describes using negatively-charged oligonucleotides and positively-charged polymers, in other embodiments, other polymers may be utilized. For example, in other embodiments, uncharged (e.g., neutral) or negatively-charged polymers may be utilized instead. It should be noted, the multilayer formation stage 208 may include one or more additional layers (e.g., metallic cations, short amines, polymer layers, etc.) as will be described below in reference to FIGS. 2 and FIG. 3. Further, in some embodiments, the multilayer formation stage 208 may form one or more additional oligonucleotide layers and/or one or more additional physically bonded polymer layers.

In some embodiments, the encapsulation stage 210 may form a shell 238 on a surface of the multilayer particles 224 to form an encapsulated particle 240. The shell 238 may include a silica encapsulation layer and/or another suitable encapsulation layer. The silica shell is generally a silicon-based compound that includes silanes that may include one or more compounds having one or more alkoxy substituents. For instance, the silanes may include one or more orthosilicates, which may include, but are not limited to, tetraalkyl orthosilicates (e.g., tetramethyl orthosilicate (also known as TMOS), tetraethyl orthosilicate (also known as tetraethoxysilane (TEOS)), tetrapropyl orthosilicate, or tetraalkyl orthosilicates that include larger alkoxy constituents, such as alkoxy groups that have more than three carbon atoms) and orthosilicates having three alkyl or alkoxy groups (e.g., tris(2-methoxyethoxy)vinylsilane). In certain embodiments, an ammonia hydroxide solution (about 28%) may be added into the reaction to catalyze the hydrolysis and condensation of silane to form the shell 238.

In some embodiments, the size of the silica core 214 (e.g., silica nanoparticle) may range from 5 nanometers (nm) to 5 microns, 5 nm to 1000 nm, 5 nm to 500 nm, 5 nm to 100 nm, 5 nm to 20 nm, and the like. In certain embodiments, the core-shell particle 218 may range from 8 nm to 5 microns, 8 nm to 1000 nm, 8 nm to 500 nm, 8 nm to 200 nm, 8 nm to 100 nm, 8 nm to 20 nm, and the like. The core double-shell particle 222 may range from 10 nm to 5 microns, 10 nm to 1000 nm, 10 nm to 500 nm, 10 to 200 nm, 10 nm to 100 nm, 10 nm to 20 nm, and the like. The multilayer particle 224 may range from 10 nm to 5 microns, 10 nm to 1000 nm, 10 nm to 500 nm, 10 nm to 200 nm, 10 nm to 100 nm, 10 nm to 20 nm, and the like. The shell 238 may serve as a protective layer and/or to improve rigidity of the tracer particle 202. A thickness of the shell 238 may range from 2 nm to 200 nm, 2 nm to 100 nm, 2 nm to 20 nm, and the like.

In some embodiments, the stabilization stage 212 may form a stabilization-assisted layer 242 (e.g., a polymer layer, a ligand layer, etc.) on the surface of the encapsulated particle 240 to form the tracer particle 202. The stabilization-assisted layer 242 may include one or more oil molecules and/or one or more polymer chains. Further, the stabilization-assisted layer 242 may form a protective barrier that may decrease aggregation of tracer particles in solution improving stability of the tracer particle 202 in a solution. The stabilization-assisted layer 242 of the tracer particle 202 may enhance the protection of the oligonucleotide layers (e.g., the first oligonucleotide layer 220, the second oligonucleotide layer 228), as well as enhance the solubility (e.g., dispersibility, suspension stability) of the tracer particle 202 in fluids, such as water or organic solvents. In some embodiments, the stabilization-assisted layer 242 may include trimethoxy(pentadecyl)silane, phenyltrimethoxysilane, diphenylchlorosilane, octadecyltrichlorosilane, polyethylene glycol (PEG), poly(N-isopropylacrylamide), dextran polymer, one or more additional component, or a combination thereof. In some embodiments, the stabilization layer 242 may form an irregular structure resulting from the growth of the stabilization layer 242 from the tracer particle 202. For example, the stabilization-assisted layer 242 may include rod-like structures, winding structures, tendril-like structures, or otherwise materials extending from an outer surface of the tracer particle 202. In some embodiments, the stabilization layer 242 may form a fibrous layer comprising a material selected from the group consisting of silica, one or more other oxides, and combinations thereof, wherein the fibrous layer exhibits either hydrophobic or hydrophilic properties to thereby improve the stability of the tracer particle 202 in a solution. In some embodiments, the fibrous layer may have a microstructure (e.g., crystals, grains, amorphous regions, or any combination thereof) imparted by the material.

After being synthesized, the tracer particles 202 may be dispersed into a fluid, such as solvent or combination of solvents, including, but not limited to a hydrophilic solvent (or solvents), a hydrophobic solvent (or solvents), or a combination thereof. The solution that includes that solvent(s) and the tracer particles 202 may be injected into subsurface formations, for example, using a pump. After the tracer particles 202 have been in the subsurface formation for a desired amount of time (e.g., several days, weeks, or months), water/oil samples can be collected at a production well. The tracer particles 202 may be extracted from samples, and the oligonucleotides may be analyzed using techniques such as, but not limited to, qPCR and next-generation sequencing (NGS).

FIG. 3 is a diagram of a process 300 to synthesize one or more tracer particles 302 including one or more amine molecules that may be used by the subterranean resource exploration and extraction system of FIG. 1, in accordance with aspects of the present disclosure. The process 300 generally produces the tracer particles 302 through the disclosed LbL techniques for use in detecting downhole conditions. In some embodiments, the tracer particles 302 may be fabricated in aqueous conditions. As shown, the process 300 may include one or more stages. The one or more stages may be used to form one or more layers including amines molecules, amine based polymers, oligonucleotides, or a combination thereof. It should be noted, that the illustrated stages are provided as examples and more, fewer, or different stages may be included in the process 300. As shown, the process 300 may include the monolayer formation stage 204, the bilayer formation stage 206, the encapsulation stage 210, and the stabilization stage 212 as described in referenced to the process 200 of FIG. 2. The process 300 may include a multilayer formation stage 304 that may include forming one or more multilayer particles 224 that may be intermediate particles formed during the process 300.

In some embodiments, the monolayer formation stage 204 includes modifying the silica core 214 with the chemically bonded amine layer 216 to form the core-shell particle 218. The bilayer formation stage 206 may include modifying the core-shell particle 218 with the first oligonucleotide layer 220 (e.g., a DNA layer) to form the core double-shell particle 222. In some embodiments, the multilayer formation stage 304 may include modifying the core double-shell particle 222 with the one or more additional layers to form the one or more multilayer particles 224. As shown, the additional layers may include a first amine molecule layer 306, a first physically bonded amine polymer layer 308, a second oligonucleotide layer 310, a second amine molecule layer 312, a second physically bonded amine polymer layer 314, and the like. The multilayer particles 224 may include a first multilayer particle 316, a second multilayer particle 318, and a third multilayer particle 320. The multilayer particles 224 may be intermediate particles formed during the process 300. The multilayer formation stage 304 may generate the first multilayer particle 316 by modifying the core double-shell particle 222 with the first amine molecule layer 306 and the first physically bonded amine polymer layer 308. The first amine molecule layer 306 may include one or more short amine molecules. For example, the first amine molecule layer 306 may include one or more polyamines such as putrescine, spermidine, spermine, thermospermine, cadaverine, agmatine, or a combination thereof. The polyamines generally include multiple amines (e.g., one or more primary amines, one or more secondary amines, one or more tertiary amines, or a combination thereof) separated by an alkyl chain having two or more carbons. The positively charged cations of the first amine molecule layer 306 and the negatively charged macromolecules (e.g., the phosphate backbone) of the first oligonucleotide layer 220 may interact (e.g., bind) via electrostatic interactions, site and/or structure specific binding (e.g., phosphate groups, DNA grooves), or a combination thereof. Without wishing to be bound by theory, the polyamines of the first amine molecule layer 306 may stabilize the first oligonucleotide layer 220. The first physically bonded amine polymer layer 308 may include PDADMAC and may interact with the first amine molecule layer 306 to form around the first oligonucleotide layer 220 and the first amine molecule layer 306, forming the first multilayer particle 316.

The multilayer formation stage 304 may generate the second multilayer particle 318 by modifying the first multilayer particle 316 with the second oligonucleotide layer 310. In an embodiment, the second oligonucleotide layer 310 may be substantially similar to the first oligonucleotide layer 220. Alternatively, the second oligonucleotide layer 310 may include oligonucleotides differing from the first oligonucleotide layer 220 enabling differentiation of the first oligonucleotide layer 220 and the second oligonucleotide layer 310 during analysis of the tracer particle 302 by the tracer particle analysis system 106 of FIG. 1. The multilayer formation stage 304 may generate the third multilayer particle 320 by modifying the second multilayer particle 318 with the second amine molecule layer 312 and the second physically bonded amine polymer layer 314. The second amine molecule layer 312 may be similar to the first amine molecule layer 306 described herein. Briefly, the second amine molecule layer 312 may include one or more polyamines that may interact with the second oligonucleotide layer 310. The second physically bonded amine polymer layer 314 may be substantially similar to the first physically bonded amine polymer layer 308.

In some embodiments, the encapsulation stage 210 may form the shell 238 on a surface of the multilayer particles 224 to form the encapsulated particle 240. The shell 238 may include the silica encapsulation layer and/or another suitable encapsulation layer as described in reference to FIG. 2. In some embodiments, the size of the silica core 214 (e.g., silica nanoparticle) may range from 5 nanometers (nm) to 5 microns, 5 nm to 1000 nm, 5 nm to 500 nm, 5 nm to 100 nm, 5 nm to 20 nm, and the like. In certain embodiments, the core-shell particle 218 may range from 8 nm to 5 microns, 8 nm to 1000 nm, 8 nm to 500 nm, 8 nm to 200 nm, 8 nm to 100 nm, 8 nm to 20 nm, and the like. The core double-shell particle 222 may range from 10 nm to 5 microns, 10 nm to 1000 nm, 10 nm to 500 nm, 10 to 200 nm, 10 nm to 100 nm, 10 nm to 20 nm, and the like. The multilayer particle 224 may range from 10 nm to 5 microns, 10 nm to 1000 nm, 10 nm to 500 nm, 10 nm to 200 nm, 10 nm to 100 nm, 10 nm to 20 nm, and the like. The shell 238 may serve as a protective layer and/or to improve rigidity of the tracer particle 302. The thickness of the shell 238 may range from 2 nm to 200 nm, 2 nm to 100 nm, 2 nm to 20 nm, and the like.

In some embodiments, the stabilization stage 212 may form the stabilization-assisted layer 242 on the surface of the encapsulated particle 240 to form the tracer particle 302. The stabilization-assisted layer 242 may include one or more oil molecules and/or one or more polymer chains as described in reference to FIG. 2. The stabilization-assisted layer 242 may form a protective barrier that may decrease aggregation of tracer particles in solution improving stability of the tracer particle 302 in a solution. After being synthesized, the tracer particles 302 may be injected into subsurface formations, for example, using a pump. After the tracer particles 302 have been in the subsurface formation for a desired amount of time (e.g., several days, weeks, or months), water/oil samples can be collected at a production well. The tracer particles 302 may be extracted from samples, and the oligonucleotides may be analyzed using techniques such as, but not limited to, qPCR and next-generation sequencing (NGS).

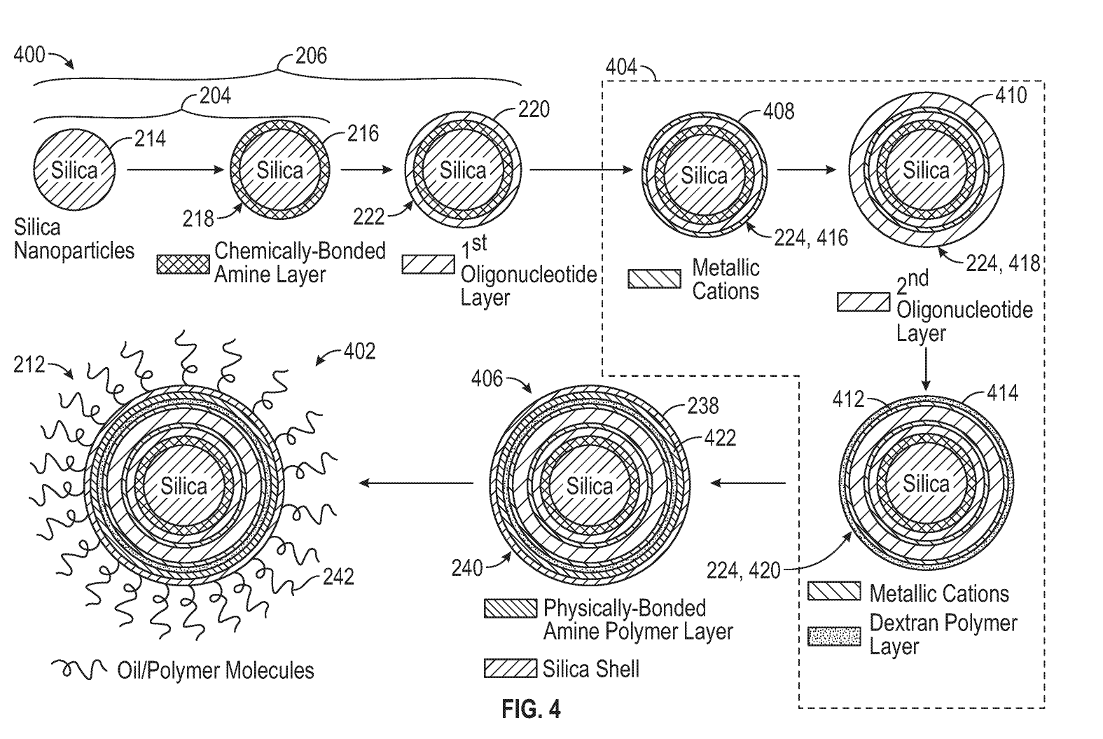

FIG. 4 is a diagram of a process 400 to synthesis one or more tracer particles 402 including one or more metallic cations that may be used by the subterranean resource exploration and extraction system of FIG. 1, in accordance with aspects of the present disclosure. The process 400 generally produces the tracer particles 402 through the disclosed LbL techniques that may be used to detect downhole conditions. In some embodiments, the tracer particles 402 may be fabricated in aqueous conditions. As shown, the process 400 may include one or more stages. The one or more stages may be used to form one or more layers including amines molecules, amine based polymers, oligonucleotides, or a combination thereof. It should be noted, that the illustrated stages are provided as examples and more, fewer, or different stages may be included in the process 400. As shown, the process 400 may include the monolayer formation stage 204, the bilayer formation stage 206, and the stabilization stage 212 as described in reference to the process 200 of FIG. 2. The process 400 may include a multilayer formation stage 404 and the encapsulation stage 406 that may include forming one or more multilayer particles 224 that may be intermediate particles formed during the process 400.

In some embodiments, the monolayer formation stage 204 includes modifying the silica core 214 with the chemically bonded amine layer 216 to form the core-shell particle 218. The bilayer formation stage 206 may include modifying the core-shell particle 218 with the first oligonucleotide layer 220 (e.g., a DNA layer) to form the core double-shell particle 222. In some embodiments, the multilayer formation stage 404 may include modifying the core double-shell particle 222 with the one or more additional layers to form the one or more multilayer particles 224. As shown, the additional layers may include a first metallic cation layer 408, a second oligonucleotide layer 410, a second metallic cation layer 412, a branched polymer layer 414, and the like. The multilayer particles 224 may include a first multilayer particle 416, a second multilayer particle 418, and a third multilayer particle 420. The multilayer particles 224 may be intermediate particles formed during the process 400. The multilayer formation stage 404 may generate the first multilayer particle 416 by modifying the core double-shell particle 222 with the first metallic cation layer 408. The first metallic cation layer 408 may include one or more metallic cations. For example, the first metallic cation layer 408 may include calcium (Ca), cobalt (Co), zinc (Zn), copper (Cu), manganese (Mn), nickel (Ni), copper (Cu), cadmium (Cd), barium (Ba), magnesium (Mg), iron (Fe), chromium (Cr), and aluminum (Al). Various metallic salts such as, but not limited to, metal halides (e.g., fluorides, chlorides, bromides, iodides), metal sulfates, and metal nitrates may be dissolved to form a metal ion solution during formation of the first multilayer particle 416.

The multilayer formation stage 404 may generate the second multilayer particle 418 by modifying the first multilayer particle 416 with the second oligonucleotide layer 410. In an embodiment, the second oligonucleotide layer 410 may be substantially similar to the first oligonucleotide layer 220. Alternatively, the second oligonucleotide layer 410 may include oligonucleotides differing from the first oligonucleotide layer 220 enabling differentiation of the first oligonucleotide layer 220 and the second oligonucleotide layer 410 during analysis of the tracer particle 302 by the tracer particle analysis system 106 of FIG. 1. The multilayer formation stage 404 may generate the third multilayer particle 420 by modifying the second multilayer particle 418 with the second metallic cation layer 412 and the branched polymer layer 414. The second metallic cation layer 412 may be similar to the first metallic cation layer 408 described herein. Briefly, the second metallic cation layer 412 may include one or more metallic cations such as Ca, Mg, Fe, Cu, and the like. The branched polymer layer 414 may include a branched polysaccharide such as dextran. The branched polymer layer 414 may form a barrier around the second oligonucleotide layer 410 and the second metallic cation layer 412.

In some embodiments, the encapsulation stage 406 may form a first physically bonded amine polymer layer 422 and the shell 238 on a surface of the multilayer particles 224 to form the encapsulated particle 240. The first physically bonded amine polymer layer 422 may include PDADMAC and may interact with the branched polymer layer 414. The shell 238 may include the silica encapsulation layer and/or another suitable encapsulation layer as described in reference to FIG. 2. In some embodiments, the size of the silica core 214 (e.g., silica nanoparticle) may range from 5 nanometers (nm) to 5 microns, 5 nm to 1000 nm, 5 nm to 500 nm, 5 nm to 100 nm, 5 nm to 20 nm, and the like. In certain embodiments, the core-shell particle 218 may range from 8 nm to 5 microns, 8 nm to 1000 nm, 8 nm to 500 nm, 8 nm to 200 nm, 8 nm to 100 nm, 8 nm to 20 nm, and the like. The core double-shell particle 222 may range from 10 nm to 5 microns, 10 nm to 1000 nm, 10 nm to 500 nm, 10 to 200 nm, 10 nm to 100 nm, 10 nm to 20 nm, and the like. The multilayer particle 224 may range from 10 nm to 5 microns, 10 nm to 1000 nm, 10 nm to 500 nm, 10 nm to 200 nm, 10 nm to 100 nm, 10 nm to 20 nm, and the like. The first physically bonded amine polymer layer 422 and the shell 238 may serve as a protective layer and/or to improve rigidity of the tracer particle 402. A thickness of the first physically bonded amine polymer layer 422 and the shell 238 may range from 2 nm to 200 nm, 2 nm to 100 nm, 2 nm to 20 nm, and the like.

In some embodiments, the stabilization stage 212 may form the stabilization-assisted layer 242 on the surface of the encapsulated particle 240 to form the tracer particle 402. The stabilization-assisted layer 242 may include one or more oil molecules and/or one or more polymer chains as described in reference to FIG. 2. The stabilization-assisted layer 242 may form a protective barrier that may decrease aggregation of tracer particles in solution improving stability of the tracer particle 402 in a solution. After being synthesized, the tracer particles 402 may be injected into subsurface formations, for example, using a pump. After the tracer particles 402 have been in the subsurface formation for a desired amount of time (e.g., several days, weeks, or months), water/oil samples can be collected at a production well. The tracer particles 402 may be extracted from samples, and the oligonucleotides may be analyzed using techniques such as, but not limited to, qPCR and next-generation sequencing (NGS).

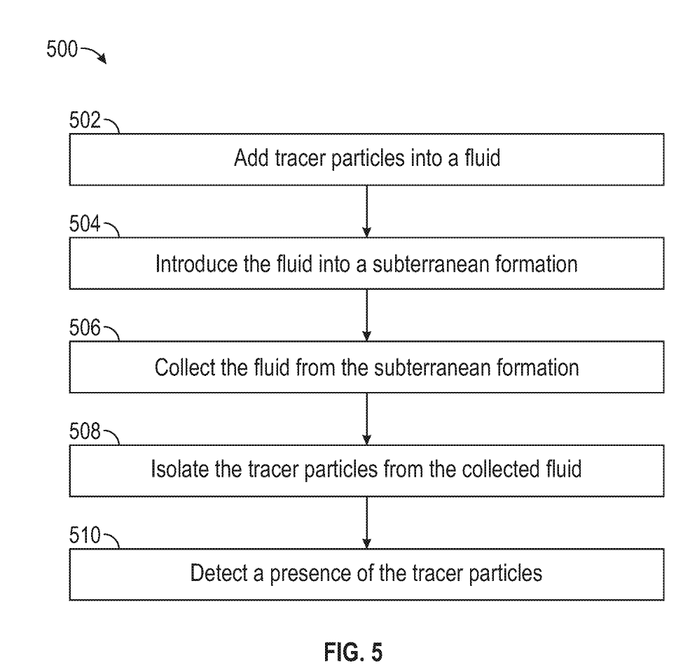

FIG. 5 is a flow diagram of a process 500 of detecting the tracer particles, in accordance with aspects of the present disclosure. The process 500 may be performed by a computing device or controller disclosed above with reference to the subterranean resource exploration and extraction system 100 of FIG. 1 or any other suitable computing device(s) or controller(s). Furthermore, the blocks of the process 500 may be performed in the order disclosed herein or in any suitable order. For example, certain blocks of the process 500 may be performed concurrently. In addition, in certain embodiments, at least one of the blocks of the process 500 may be omitted. The process 500 may include any or all of the features discussed in detail above with reference to FIGS. 1-4.

At block 502 of the process 500, the subterranean resource exploration and extraction system 100 may add a plurality of tracer particles into a fluid. The plurality of tracer particles may include the tracer particles 202 including the physically bonded amine polymer layers 226, 230 described in FIG. 2, the tracer particles 302 including the amine molecule layers 306, 312 described in FIG. 3, the tracer particles 402 including the metallic cation layers 408, 412 described in FIG. 4, or a combination thereof. Briefly, the plurality of tracer particles may include one or more oligonucleotide layers, one or more physically bonded amine polymer layers, one or more amine layers, one or more metallic cation layers, one or more branched polymer layers, a silica shell, a stabilization-assisted layer, or a combination thereof. The fluid may include a working fluid, a hydraulic fracking fluid, water, and the like.

At block 504 of the process 500, the subterranean resource exploration and extraction system 100 may introduce the fluid into a subterranean formation. The fluid may be introduced into the subsurface formation via an inlet. At block 506 of the process 500, the subterranean resource exploration and extraction system 100 may collect the fluid from the subterranean formation. It should be noted, in some embodiments, the fluid may be measured in situ in the subsurface formation. The collected fluid may include a suspension of the fluid and the tracer particles.

At block 508 of the process 500, the subterranean resource exploration and extraction system 100 may detect a presence of the tracer particles. Detection of the tracer particles may be based on detection of one or more layers and/or fragments of the tracer particles. The tracer particle may be detected based on physical properties (e.g., magnetic properties, chemical properties, optical properties). For example, the tracer particles in the collected fluid may be digested to enable measurement of one or more chemical fragments (e.g., amines, oligonucleotides, DNA fragments, metallic cations, etc.) from the layers of the tracer particles. In some embodiments, an identify of one or more layers of the tracer particles may be determined by quantitative PCR (qPCR) instruments, deoxyribonucleic acid (DNA) amplifiers, or any other suitable equipment utilized to process or sequence DNA or ribonucleic acid (RNA) (e.g., sequencers, spectrometers, flow cytometers, gel electrophoresis equipment). In this manner, a presence or an absence of the tracer particles may be detected to provide information related to the environment of the subsurface formation. For example, the chemical and/or environmental properties of one or more zones of the subsurface formation may be determined based on the tracer particles in the collected fluid.

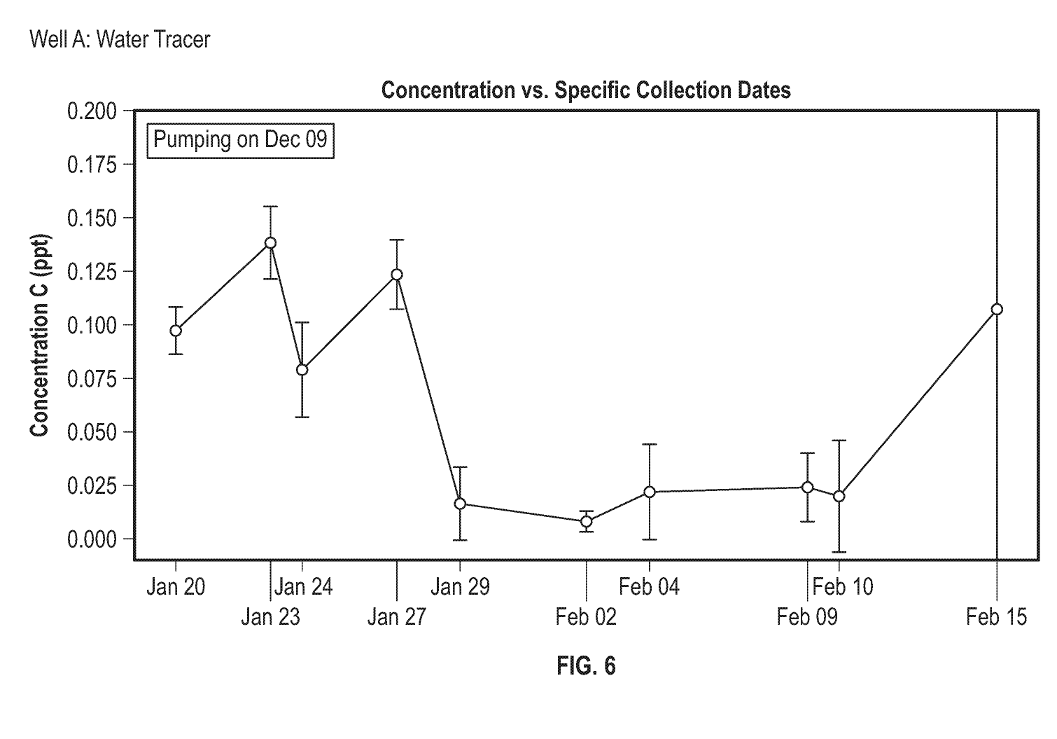

The tracer particle 202 is capable of being detected at concentrations on the order of parts per trillion (ppt), parts per billion (ppb), parts per million (ppm), or higher concentrations. FIGS. 6-8 show graphs of detected concentrations of tracer particles (e.g., via samples collected from a well) that are functionalized with a stabilization-assisted layer 242. In these examples, less than 1 kilogram (kg) of tracer particles 202 were provided in (e.g., pumped into) a well. A sample (e.g., less than 100 mL, about 20 to about 50 mL) was collected at different time periods (e.g., weeks, one or more months) from the well site. The concentrations were determined using quantitative PCR and oligonucleotide sequencing as discussed herein.

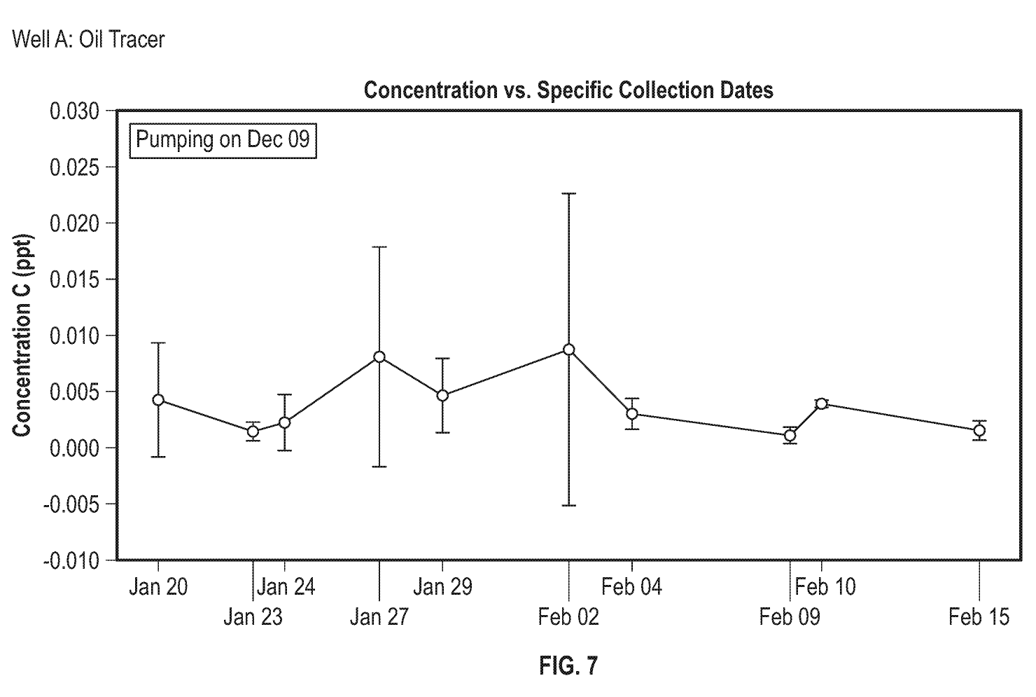

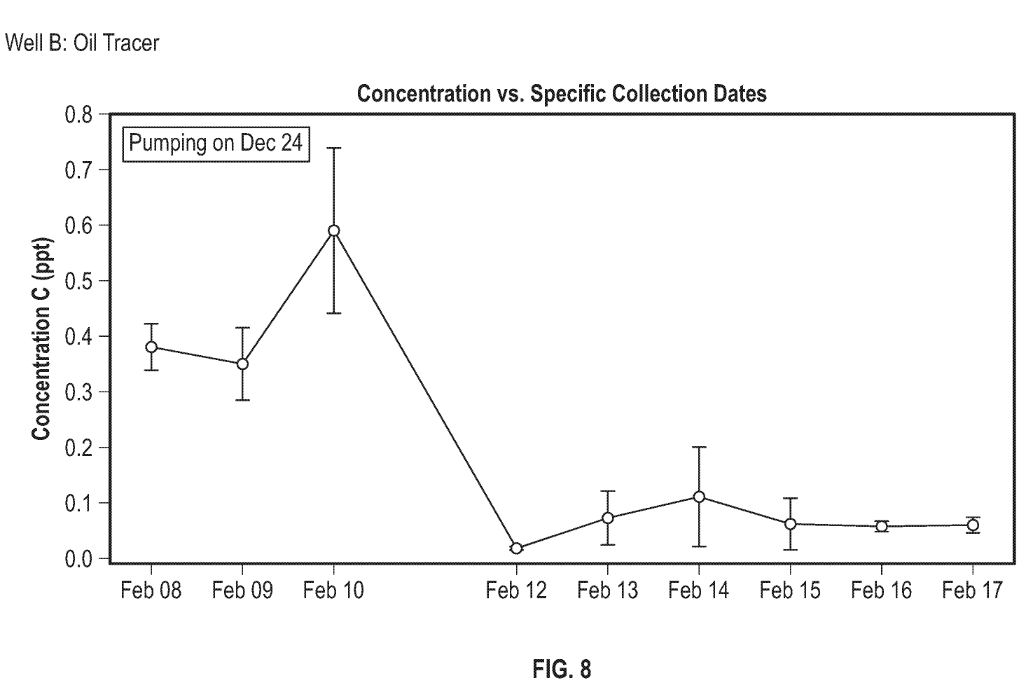

FIG. 6 is a graph of concentration (y-axis) of water-soluble tracer particles 202 collected during different time periods (x-axis) from a first well. For example, the tracer particle 202 includes a stabilization-assisted layer 242 that facilitates dispersing the tracer particle 202 in water or otherwise an aqueous solution. FIG. 7 is a graph of concentration (y-axis) of oil soluble tracer particles 202 collected during different time periods (x-axis) from the first well. For example, the tracer particle 202 includes a stabilization-assisted layer 242 that facilitates dispersing the tracer particle 202 in oil or otherwise a hydrophobic or non-polar liquid. FIG. 8 is a graph of concentration (y-axis) of oil soluble tracer particles 202 collected during different time periods (x-axis) from a second well. For example, the tracer particle 202 includes a stabilization-assisted layer 242 that facilitates dispersing the tracer particle 202 in water or otherwise an aqueous solution. As shown, the tracer particle 202 is capable of being detected at concentrations as low as about 0.01 ppt about two months after initially being pumped into respective wells. Accordingly, the disclosed techniques may provide information regarding the flow of subsurface fluids (e.g., flow paths, flow rates, flow loss) within the subsurface formation 108 using relatively small amounts of tracer particles 202 and over relatively long time periods (e.g., more than a week, more than a month, several months).

As described in detail above, present embodiments include a tracer particle that may be utilized to determine information regarding the flow of fluids (e.g., hydrocarbons or water) in a subsurface formation. The tracer particle includes oligonucleotides that may be recovered by digesting the tracer particles and then sequenced to enable positive identification of the tracer particle. The tracer particle includes layers of oligonucleotides, polymers, amines, and/or metallic cations. Such layers are formed through the disclosed LbL techniques based on chemical and physical interactions between one or more layers formed on a silica nanoparticle. Additionally, in certain embodiments, the tracer particles include an outer stabilization-assisted layer that further protects the multilayer particle and enhances the solubility of the tracer particle in a particular hydrophobic or hydrophilic fluid for injection. The multiple layers of the tracer particle protect the oligonucleotides from degrading (e.g., denaturing) while in conditions including high-pressures, high-temperatures, salinity, acidity, and/or basicity. Accordingly, the present embodiments enable robust tracer particles to be synthesized, injected with a fluid into a subsurface formation, recovered from the fluid, and characterized for positive identification.

The subject matter described in detail above may be defined by one or more clauses, as set forth below.

A tracer particle includes a layer-by-layer structure. The layer-by-layer structure includes a core and a plurality of layers that surround the core. The plurality of layers includes a chemically bonded amine layer, one or more oligonucleotide layer, and one or more physically bonded amine polymer layers. The layer-by-layer structure also includes a shell that surrounds the plurality of layers. Further, the layer-by-layer structure includes a stabilization-assisted layer coupled to an outer surface of the shell.

The tracer particle of any preceding clause, wherein the plurality of layers further includes an amine molecule layer between at least one of the one or more oligonucleotide layers and at least one of the one or more physically bonded amine polymer layers.

The tracer particle of any preceding clause, wherein the plurality of layers further includes one or more metallic cation layers.

The tracer particle of any preceding clause, wherein the plurality of layers further includes one or more branched polymer layers.

The tracer particle of any preceding clause, wherein the chemically bonded amine layer includes N-[3-(Trimethoxysilyl)propyl]ethylenediamine, 3-aminopropyltriethoxysilane, or one or more additional type of silane coupling agent.

The tracer particle of any preceding clause, wherein the stabilization-assisted layer includes one or more oil molecules, one or more polymers, or a combination thereof.

The tracer particle of any preceding clause, wherein the shell includes a silica shell and wherein the core includes a silica core.

The tracer particle of any preceding clause, wherein the one or more physically bonded amine polymer layers include poly(diallyldimethylammonium chloride).

The tracer particle of any preceding clause, wherein the tracer particle has a diameter between about 40 nanometers (nm) and 5 microns.

The tracer particle of any preceding clause, wherein the tracer particle protects the one or more oligonucleotide layers from degrading when the tracer particle is subjected to high temperatures, high pressures, high-salinity, high-acidity, or a combination thereof.

The tracer particle of any preceding clause, wherein the one or more physically bonded amine polymer layers include one or more positively charged portions, and wherein the one or more oligonucleotide layers include one or more negatively charged portions.

A method includes adding a plurality of tracer particles into a fluid. Each of the plurality of tracer particles includes a layer-by-layer structure including a core. The layer-by-layer structure also includes a plurality of layers that surround the core. The plurality of layers includes a chemically bonded amine layer, one or more oligonucleotide layers, and one or more physically bonded amine polymer layers. The layer-by-layer structure also includes a shell that surrounds the plurality of layers. Further the layer-by-layer structure includes a stabilization-assisted layer coupled to an outer surface of the shell introducing the fluid into subterranean formation. The method also includes detecting a presence of the plurality of tracer particles.

The method of any preceding clause, wherein detecting the presence of the plurality of tracer particles includes detecting the presence of the plurality of tracer particles within the subterranean formation.

The method of any preceding clause, wherein detecting the plurality of tracer particles includes detecting the plurality of tracer particles using an optical sensor.

The method of any preceding clause, including collecting a sample from the subterranean formation, the sample including at least a portion of the plurality of tracer particles; and isolating the portion of the plurality of tracer particles from the sample.

The method of any preceding clause, including isolating a portion of the one or more oligonucleotide layers from the portion of the plurality of tracer particles; identifying one or more sequences from the portion of the one or more oligonucleotide layers; and determining a flow of subsurface fluids within the subterranean formation based on identifying the oligonucleotides.

A tracer particle includes a layer-by-layer structure. The layer-by-layer structure includes a core. The layer-by-layer structure also includes a plurality of layers that surround the core. The plurality of layers includes a chemically bonded amine layer, one or more oligonucleotide layers, and one or more metallic cation layers. Further, the layer-by-layer structure includes a branched polymer layer surrounding the plurality of layers. Further still, the layer-by-layer structure includes a shell that surrounds the branched polymer layer. Even further, the layer-by-layer structure includes a stabilization-assisted layer coupled to an outer surface of the shell.

The tracer particle of any preceding clause, wherein the metallic cation layers include calcium, magnesium, iron, copper, or a combination thereof.

The tracer particle of any preceding clause, wherein the chemically bonded amine layer includes N-[3-(Trimethoxysilyl)propyl]ethylenediamine, 3-aminopropyltriethoxysilane, or one or more additional type of silane coupling agent.

The tracer particle of any preceding clause, wherein the tracer particle has a diameter between about 40 nanometers (nm) and 5 microns.

The tracer particle of any preceding clause, wherein the core further includes one or more metal oxide particles or one or more polymeric particles.

The tracer particle of any preceding clause, wherein one or more surfaces of the one or more metal oxide particles or the one or more polymeric particles are intrinsically positively charged or positively charged by one or more positively chaired functional groups on the one or more surfaces of the one or more metal oxide particles or the one or more polymeric particles.

This written description uses examples to disclose the present embodiments, including the best mode, and also to enable any person skilled in the art to practice the present embodiments, including making and using any devices or systems and performing any incorporated methods. The patentable scope of the present embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A tracer particle, comprising:
a layer-by-layer structure comprising:
a core;
a plurality of layers that surround the core, wherein the plurality of layers comprises:
a chemically bonded amine layer;
one or more oligonucleotide layers; and
one or more physically bonded amine polymer layers;
a shell that surrounds the plurality of layers; and
a stabilization-assisted layer coupled to an outer surface of the shell.

2. The tracer particle of claim 1, wherein the plurality of layers further comprises an amine molecule layer between at least one of the one or more oligonucleotide layers and at least one of the one or more physically bonded amine polymer layers.

3. The tracer particle of claim 1, wherein the plurality of layers further comprises one or more metallic cation layers.

4. The tracer particle of claim 1, wherein the plurality of layers further comprises one or more branched polymer layers.

5. The tracer particle of claim 1, wherein the chemically bonded amine layer comprises N-[3-(Trimethoxysilyl)propyl]ethylenediamine, 3-aminopropyltriethoxysilane, or one or more additional type of silane coupling agent.

6. The tracer particle of claim 1, wherein the stabilization-assisted layer comprises one or more oil molecules, one or more polymers, or a combination thereof.

7. The tracer particle of claim 1, wherein the shell comprises a silica shell and wherein the core comprises a silica core.

8. The tracer particle of claim 1, wherein the one or more physically bonded amine polymer layers comprise poly(diallyldimethylammonium chloride).

9. The tracer particle of claim 1, wherein the tracer particle has a diameter between about 40 nanometers (nm) and 5 microns.

10. The tracer particle of claim 1, wherein the tracer particle protects the one or more oligonucleotide layers from degrading when the tracer particle is subjected to high temperatures, high pressures, high-salinity, high-acidity, or a combination thereof.

11. The tracer particle of claim 1, wherein the one or more physically bonded amine polymer layers comprise one or more positively charged portions, and wherein the one or more oligonucleotide layers comprise one or more negatively charged portions.

12. A method, comprising:
adding a plurality of tracer particles into a fluid, wherein each of the plurality of tracer particles comprises a layer-by-layer structure comprising:
a core;
a plurality of layers that surround the core, wherein the plurality of layers comprises:
a chemically bonded amine layer;
one or more oligonucleotide layers; and
one or more physically bonded amine polymer layers;
a shell that surrounds the plurality of layers; and
a stabilization-assisted layer coupled to an outer surface of the shell introducing the fluid into subterranean formation; and
detecting a presence of the plurality of tracer particles.

13. The method of claim 12, wherein detecting the presence of the plurality of tracer particles comprises detecting the presence of the plurality of tracer particles within the subterranean formation.

14. The method of claim 13, wherein detecting the plurality of tracer particles comprises detecting the plurality of tracer particles using an optical sensor.

15. The method of claim 12, comprising:
collecting a sample from the subterranean formation, the sample comprising at least a portion of the plurality of tracer particles; and
isolating the portion of the plurality of tracer particles from the sample.

16. The method of claim 12, comprising:
isolating a portion of the one or more oligonucleotide layers from the portion of the plurality of tracer particles;
identifying one or more sequences from the portion of the one or more oligonucleotide layers; and
determining a flow of subsurface fluids within the subterranean formation based on identifying the oligonucleotides.

17. A tracer particle, comprising:
a layer-by-layer structure comprising:
a core; and
a plurality of layers that surround the core, wherein the plurality of layers comprises:
a chemically bonded amine layer;
one or more oligonucleotide layers; and
one or more metallic cation layers;
a branched polymer layer surrounding the plurality of layers;
a shell that surrounds the branched polymer layer; and
a stabilization-assisted layer coupled to an outer surface of the shell.

18. The tracer particle of claim 17, wherein the metallic cation layers comprise calcium, magnesium, iron, copper, or a combination thereof.

19. The tracer particle of claim 17, wherein the chemically bonded amine layer comprises N-[3-(Trimethoxysilyl)propyl]ethylenediamine, 3-aminopropyltriethoxysilane, or one or more additional type of silane coupling agent.

20. The tracer particle of claim 17, wherein the tracer particle has a diameter between about 40 nanometers (nm) and 5 microns.

21. The tracer particle of claim 1, wherein the core further comprises one or more metal oxide particles or one or more polymeric particles.

22. The tracer particle of claim 21, wherein one or more surfaces of the one or more metal oxide particles or the one or more polymeric particles are intrinsically positively charged or positively charged by one or more positively chaired functional groups on the one or more surfaces of the one or more metal oxide particles or the one or more polymeric particles.
